(19) United States
(12) Patent Application Publication
(10) Pub. No.: US 2023/0066510 A1
(43) Pub. Date: Mar. 2, 2023

(54) MOVEMENT INSTRUCTION DEVICE AND METHOD

(71) Applicant: TOSHIBA TEC KABUSHIKI KAISHA, Tokyo (JP)

(72) Inventors: Masaaki Yasunaga, Sunto Shizuoka (JP); Norimasa Ariga, Izunokuni Shizuoka (JP)

(21) Appl. No.: 17/840,656

(22) Filed: Jun. 15, 2022

(30) Foreign Application Priority Data
Sep. 2, 2021 (JP) 2021-143461

(51) Int. Cl. G05D 1/10; B64C 39/02

(52) U.S. Cl. CPC G05D 1/106; B64C 39/024; B64C 2201/108; B64C 2201/127

(57) ABSTRACT

According to one embodiment, a movement instruction device and a method capable of avoiding a risk when a movable object moves are provided. The movement instruction device includes: a storage device that stores map information for determining a movement path of an indoor movable object to a destination; and a processor that sets a movement prohibition area of the movable object in the map information based on information on an obstacle obtained from outside, and reviews the movement path of the movable object based on a current position, the destination, and the set movement prohibition area of the movable object.

### CROSS-REFERENCE TO RELATED APPLICATION

This application is based upon and claims the benefit of priority from Japanese Patent Application No. 2021-143461, filed on Sep. 2, 2021, the entire contents of which are incorporated herein by reference.

### FIELD

Embodiments described herein relate generally to a movement instruction device and a method.

### BACKGROUND

In the related art, a self-propelled robot (movable object) is allowed to travel in a store or a warehouse (hereinafter, referred to as “in a store”) to manage the number, a display position, and the like of an article displayed on a shelf or the like. By capturing an image of the article with a camera provided in the self-propelled robot, the number and the display position of the article are confirmed. Recently, similar processing is performed using a flight object (movable object) such as a drone.

The movable object manages the article by capturing an image of the article while moving in the store. On the other hand, the movable object is required to move while avoiding obstacles such as walking persons or temporarily stacked articles in the store. However, the movable object moves while capturing an image of the surroundings with the camera mounted thereon. Therefore, a large number of shelves may be blind spots of the movable object for finding an obstacle, the movable object may not recognize the obstacle, and a risk when the movable object moves may not be avoided.

### DESCRIPTION OF THE DRAWINGS

FIG. 1 is a schematic diagram illustrating a review of a movement path of a flight object according to a first embodiment;

FIG. 2 is a diagram illustrating an image of a person captured by a fixed-point camera;

FIG. 3 is a diagram illustrating changes in a destination of the flight object;

FIG. 4 is a diagram illustrating the flight object on standby;

FIG. 5 is a block diagram illustrating examples of hardware configurations of a flight instruction device and the flight object;

FIG. 6 is a functional block diagram illustrating examples of functional configurations of the flight instruction device;

FIG. 7 is a flowchart illustrating a flow of control;

FIG. 8 is a flowchart illustrating a flow of control relating to a review of a flight path;

FIG. 9 is a flowchart illustrating a flow of control of the flight object;

FIG. 10 is a schematic diagram illustrating a review of a travel path of a self-propelled robot according to a second embodiment;

FIG. 11 is a diagram illustrating changes in a destination of the self-propelled robot;

FIG. 12 is a diagram illustrating the self-propelled robot on standby;

FIG. 13 is a block diagram illustrating examples of hardware configurations of a prohibition area information generator and the self-propelled robot;

FIG. 14 is a functional block diagram illustrating an example of functional configurations;

FIG. 15 is a flowchart illustrating a flow of control of the prohibition area information generator; and

FIG. 16 is a flowchart illustrating a flow of control of the self-propelled robot.

### DETAILED DESCRIPTION

In general, according to one embodiment, a movement instruction device and a method capable of avoiding a risk when a movable object moves are provided.

A movement instruction device according to an embodiment includes: a storage device that stores map information for determining a movement path of an indoor movable object to a destination; and a processor that sets a movement prohibition area of the movable object in the map information based on information on an obstacle obtained from outside, and reviews the movement path of the movable object based on a current position, the destination, and the set movement prohibition area of the movable object.

Hereinafter, a movement instruction device and a method according to a first embodiment and a second embodiment will be described with reference to drawings. The first embodiment and the second embodiment are embodiments of the movement instruction device and the method, and configurations, functions, and the like thereof do not limit the embodiments disclosed herein. In the first embodiment and the second embodiment, a person will be described as an example of an obstacle.

### First Embodiment

In the first embodiment, a flight instruction device will be described as an example of the movement instruction device. In the first embodiment, a flight object will be described as an example of the movable object.

A large number of shelves are arranged indoors of a store, a warehouse, or the like (hereinafter referred to as “store” as a representative). These shelves are provided with a plurality of stages of product placing portions, and may be shelves having a large height. Products (an example of articles) are displayed on these shelves.

The flight object such as a drone flies in a space between a ceiling and the shelves of a store N to reach a destination in the store. When the flight object reaches the destination, a camera mounted on the flight object captures an image of a product displayed on a shelf located nearby. Once captured, the flight object will fly to a next destination. By repeating such a flight, the flight object captures images of the status of required shelves and products in the store. A manager or the like of the store determines whether the sufficient number of products are displayed on the shelves based on the images captured by the flight object, and replenishes the shelves with products if necessary. Based on the images captured by the flight object, the manager or the like checks whether the products are displayed in correct positions on the shelves, and when the positions are not correct, moves the products to the correct positions. The manager or the like checks whether electronic shelf labels correctly display product information based on the images captured by the flight object.

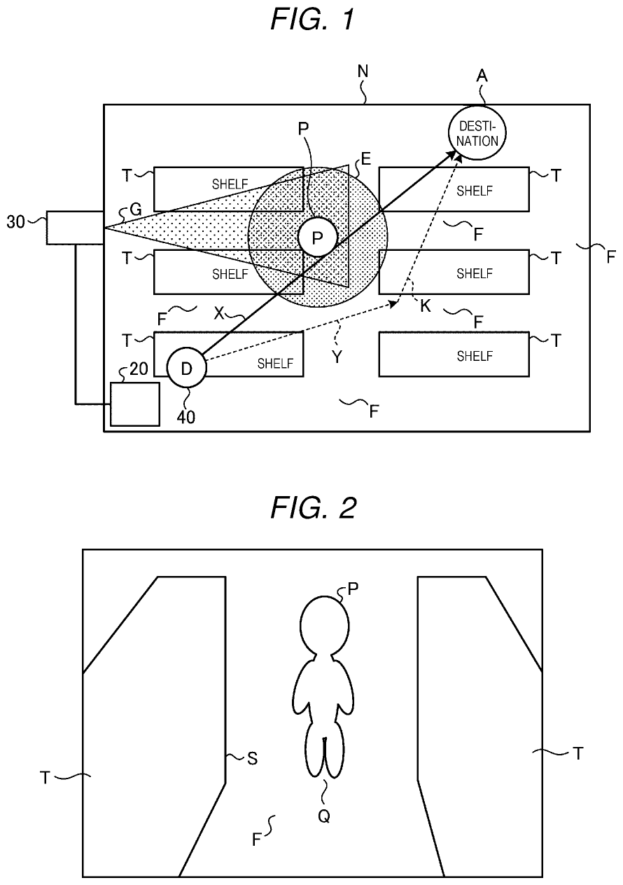

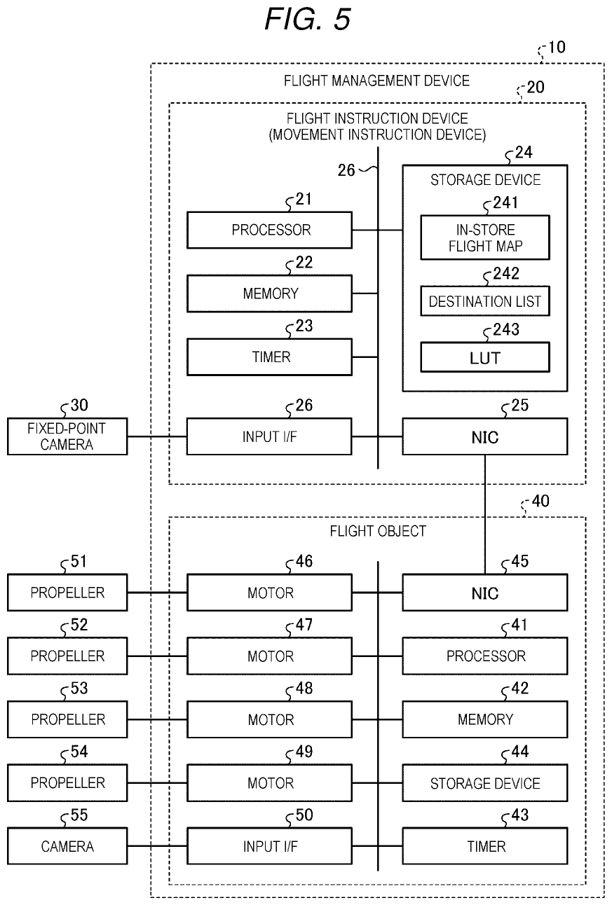

FIG. 1 is a schematic diagram illustrating a review of a flight path (movement path) of a flight object 40 (see FIG. 5) according to the first embodiment. As illustrated in FIG. 1, for example, six shelves T are arranged in the store N. Passages F are provided between the shelves T. A person P such as a customer shopping in the store N or an employee passes through the passage F.

A fixed-point camera 30 that captures an image of the store at a fixed point is fixedly attached to the store N. The fixed-point camera 30 captures, in an imaging range G, an image of the person P who passes through the passage F. The fixed-point camera 30 is attached to the ceiling or a high place of the store N in order to reliably capture the image of the person P who passes through the passage F. One fixed-point camera 30 is provided in FIG. 1. Alternatively, the number of the fixed-point camera 30 may be increased or decreased according to the scale of the store N or the number of the shelves T, and an appropriate number of the fixed-point cameras 30 are desirably attached to appropriate positions so that blind spots in the store N for images captured by the fixed-point camera 30 can be avoided as much as possible.

A flight instruction device 20, which is an example of the movement instruction device, is installed in the store N. The flight instruction device 20 transmits information on instructions (a takeoff instruction, a flight (movement) instruction to the destination, a hovering instruction, a landing instruction, or the like) to the flight object 40. Here, the flight instruction is an instruction related to a moving direction and a speed in a forward direction, a rearward direction, a leftward direction, a rightward direction, an upward direction, and a downward direction corresponding to a location.

The flight instruction device 20 creates a flight path along which the flight object 40 flies to the destination. As illustrated in FIG. 1, the flight instruction device 20 controls the flight object 40 to take off, creates a flight path (hereinafter, referred to as a “flight path X”) that is substantially straight to a destination A, and controls the flight object 40 to fly along the created flight path. However, when the person P is located in the flight path X, that is, when the flight object 40 would fly over the person P based on the image captured by the fixed-point camera 30, the flight instruction device 20 sets a flight prohibition area E based on a position of the person P. A procedure at this time may include first setting the flight prohibition area E based on the position of the person P and confirming whether the flight prohibition area is included in the flight path X. The flight instruction device 20 reviews the flight path such that the flight path X to the destination A does not pass through the created flight prohibition area E. That is, the flight instruction device 20 creates and resets a flight path Y in which the flight prohibition area E is bypassed. The flight instruction device 20 transmits information that instructs the flight object 40 to fly based on the reset flight path Y. In the embodiment, the flight instruction device 20 reviews the initially set flight path X, and creates and resets the flight path Y along which the flight object 40 bypasses the flight prohibition area E and reaches the destination A through a passing point K.

In the first embodiment, when the flight path to the destination A is changed, the flight path Y that passes through the passing point K is reset. However, to be exact, the flight instruction device 20 repeats a flight operation of setting a target location close to the destination A each time on the way to the destination A, setting a next destination while considering the flight prohibition area E when the destination is reached, and controlling the flight object 40 to fly to the next destination, and finally controls the flight object 40 to reach the destination A through the passing point K.

FIG. 2 illustrates an example of an image of the person P captured by the fixed-point camera 30 in the imaging range G. In FIG. 2, the fixed-point camera 30 captures an image of two shelves T and the person P located in the passage F between the shelves T. Although details will be described later, the flight instruction device 20 acquires the position (coordinates) of the person P based on a distance between a corner portion S of the shelf T and a position Q where the person P stands and a moving direction of the person P in the image captured by the fixed-point camera 30. The flight instruction device 20 sets the flight prohibition area E centered on the acquired position of the person P. The flight prohibition area E is, for example, within a predetermined circumference (for example, a radius of 1 m) centered on the position (coordinates) of the person P. Although details will be described later, the flight instruction device 20 may set the flight prohibition area E centered on a position (a position to which the person P is expected to move when the flight object 40 reaches) shifted to a certain extent in a direction in which the person P moves from the acquired position of the person P in consideration of the time for the flight object 40 to reach the position of the person P.

Next, a case where the destination is changed will be described. Depending on the positions and the number of the person P in the store N, the flight object 40 may fail in reaching the initially set destination A. In such a case, the flight instruction device 20 may change the destination, and when there is no alternative destination, stop the flight of the flight object 40 and keep the flight object 40 on standby.

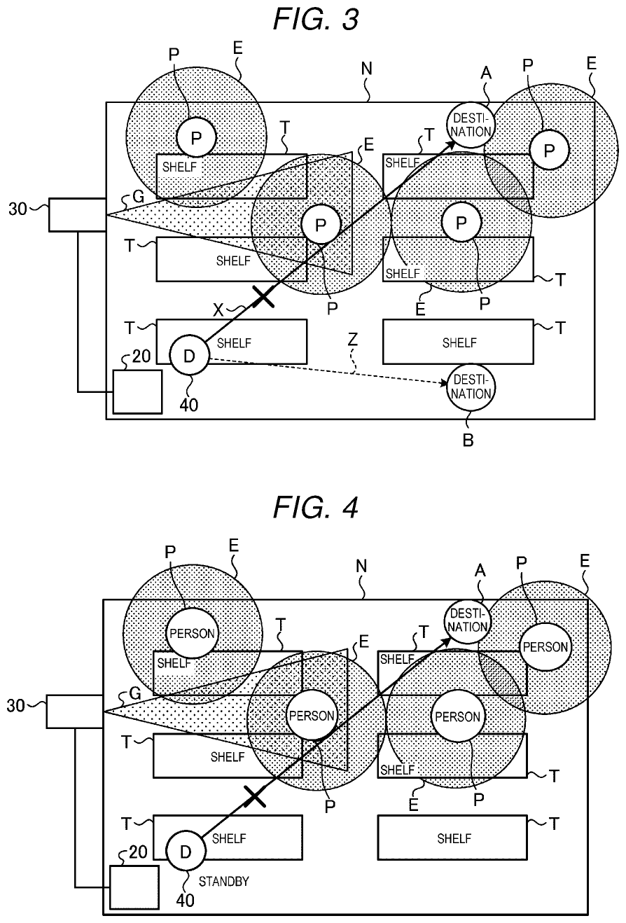

FIG. 3 is a diagram illustrating changes in the destination of the flight object 40. In FIG. 3, there are four persons P in the store. The flight instruction device 20 sets the flight prohibition areas E based on the positions of the respective persons P. In FIG. 3, as a result of reviewing the flight path, the flight instruction device 20 determines that the flight path along which the flight object 40 flies to the destination A cannot be reset due to the presence of the set flight prohibition areas E, and the destination is changed to, for example, a destination B to which the flight object 40 was scheduled to fly after reaching the destination A. The changed flight path to the destination B is a flight path Z. The flight instruction device 20 controls the flight object 40 to fly along the flight path Z.

FIG. 4 is a diagram illustrating the flight object 40 on standby. In FIG. 4, there are four persons P in the store N. The flight instruction device 20 sets the flight prohibition areas E based on the positions of the respective persons P. In FIG. 4, as a result of reviewing the flight path, the flight instruction device 20 determines that the flight path along which the flight object 40 flies to the destination A cannot be created due to the presence of the set flight prohibition areas E. For example, when no destination other than the destination A is set for the flight object 40, the flight instruction device 20 controls the flight object 40 to standby without flying from a current position of the flight object 40. The standby means, for example, controlling the flight object 40 to hover above the current position at a position where the flight instruction device 20 determines that the flight object 40 cannot fly to the destination A. Alternatively, the standby means, for example, controlling the flight object 40 to land at the position where the flight instruction device 20 determines that the flight object 40 cannot fly to the destination A.

Hereinafter, hardware configurations of the flight instruction device 20 and the flight object 40 will be described. The flight instruction device 20 and the flight object 40 are collectively referred to as a flight management device 10. That is, the flight management device 10 includes the flight instruction device 20 and the flight object 40.

FIG. 5 is a block diagram illustrating examples of the hardware configurations of the flight instruction device 20 and the flight object 40. The flight instruction device 20 includes, a processor 21 including a central processing unit (CPU) and the like, a memory 22 including a read only memory (ROM), a random access memory (RAM), or the like, a timer 23, a storage device 24, a network interface card (NIC) 25, and an input I/F 26. The processor 21 serves as a control subject. The memory 22 stores and loads various programs and data. The timer 23 counts time. The processor 21 operates in accordance with a control program stored in the memory 22 to execute control processing of the flight instruction device 20 to be described later. The NIC 25 is a card-type expansion device for connecting to a communication network.

The storage device 24 includes a nonvolatile memory such as a hard disc drive (HDD) or a flash memory in which stored information is retained even when power is turned off, and stores a control program that controls the flight instruction device 20.

The storage device 24 stores an in-store flight map 241, a destination list 242, and a look up table (LUT) 243. The in-store flight map 241 stores, for example, information on an in-store map shown in FIG. 1. The in-store flight map 241 stores map information that represents a position of an object such as the shelf T fixedly installed in the store N in the form of a map. The in-store flight map 241 stores information on the current position (coordinates) of the flight object 40, information on a position (coordinates) of the destination, and information on the flight path from the current position to the destination. The destination list 242 stores coordinates (more precisely, the coordinates of the passage F that faces the shelf T and in which an image of the shelf T can be captured) of a position of the destination (for example, a position of the shelf T) of the flight of the flight object 40. There are a plurality of positions of the destinations, for example, at least the number of shelves T. When each shelf T has a plurality of product placing portions, the destination list 242 stores positions (coordinates) corresponding to the respective product placing portions as the destinations. When one or more destinations are selected from the destination list 242, the coordinates indicating the positions of the selected destinations are stored on the in-store flight map 241.

The look up table (LUT) 243 refers to a data structure such as an array or an associative array created to improve efficiency by replacing complicated calculation processing with simple array reference processing. For example, when a computer is controlled to perform processing that imposes a large burden, data that can be calculated first is calculated in advance, and the value thereof is stored in the array (lookup table). The computer can reduce the burden of calculation and perform processing efficiently by extracting target data from the array instead of performing the calculation each time. When expensive calculation processing and input and output processing are replaced by table lookup, the processing time can be greatly reduced. In the first embodiment, a position of a person calculated based on a large number of data indicating the distance between the position of the shelf T and the position of the person P with respect to the shelf T and the moving direction of the person P is stored in the LUT 243, and the distance between the shelf T and the person P and the moving direction of the person P acquired based on the image captured by the fixed-point camera 30 are substituted into the LUT 243, whereby the coordinates indicating the position of the person P can be extracted. The input I/F 26 is connected to the fixed-point camera 30. The image captured by the fixed-point camera 30 is input to the flight instruction device 20 via the input I/F 26.

The flight object 40 includes, a processor 41 including a CPU and the like, a memory 42 including a ROM, a RAM, or the like, a timer 43, a storage device 44, a NIC 45, motors 46, 47, 48, 49, and an input I/F 50. The processor 41 serves as a control subject. The memory 42 stores and loads various programs and data. The timer 43 counts time. The processor 41 operates in accordance with a control program stored in the memory 42 to execute control processing of the flight object 40 to be described later.

The memory 42 stores instruction information related to the flight of the flight object 40 received from the flight instruction device 20. The storage device 44 includes a nonvolatile memory such as an HDD or a flash memory in which stored information is retained even when power is turned off, and stores a control program that controls the flight object 40.

The timer 43 counts time. The motor 46 rotates a propeller 51. A rotation speed of the propeller 51 changes according to a rotation speed of the motor 46. The motor 47 rotates a propeller 52. A rotation speed of the propeller 52 changes according to a rotation speed of the motor 47. The motor 48 rotates a propeller 53. A rotation speed of the propeller 53 changes according to a rotation speed of the motor 48. The motor 49 rotates a propeller 54. A rotation speed of the propeller 54 changes according to a rotation speed of the motor 49. The processor 41 rotates the propellers 51 to 54 so that the flight object 40 takes off, flies, hovers, and lands.

The input I/F 50 is connected to a camera 55. The camera 55 is a camera mounted on the flight object 40. The camera 55 captures images of the surroundings of the flight object 40. The processor 41 adjusts the rotation speeds of the motors 46 to 49 based on the captured images of the camera 55, and controls the flight object 40 not to collide with the shelves T, the person P, or the like. The NIC 45 and the NIC 25 are connected via a communication line such as a local area network (LAN), and transmit and receive information between the flight instruction device 20 and the flight object 40.

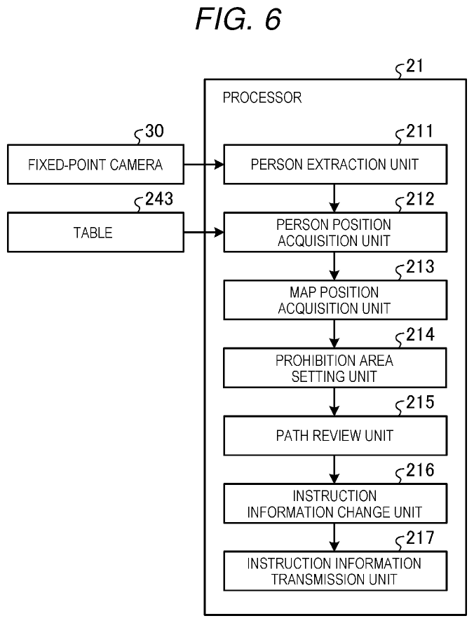

Hereinafter, functional configurations of the flight instruction device 20 will be described. FIG. 6 is a functional block diagram illustrating examples of the functional configurations of the flight instruction device 20. As illustrated in FIG. 6, the processor 21 of the flight instruction device 20 functions as a person extraction unit 211, a person position acquisition unit 212, a map position acquisition unit 213, a prohibition area setting unit 214, a path review unit 215, an instruction information change unit 216, and an instruction information transmission unit 217 in accordance with the control program stored in the memory 22.

The person extraction unit 211 (processor 21) extracts the image of the person P from the image captured by the fixed-point camera 30 (that is, information on the person P obtained from the outside). Specifically, when an image captured by the fixed-point camera 30 is acquired, the person extraction unit 211 extracts the image of the person P from the image.

The person position acquisition unit 212 (processor 21) acquires a position (coordinates) of the captured person P based on the image of the person P extracted by the person extraction unit 211. Specifically, based on the extracted image of the person P, the person position acquisition unit 212 inputs, to the LUT 243, data of a distance from the position of the surrounding shelf T to the position of the person P and the moving direction of the person P, and obtains the position (coordinates) of the person P output from the LUT 243 as the output, thereby acquiring the position (coordinates) of the person P.

The map position acquisition unit 213 (processor 21) acquires a position of the person P on the in-store flight map 241 from the position of the person P in the image captured by the fixed-point camera 30. Specifically, the map position acquisition unit 213 acquires the position on the in-store flight map 241 based on the position (coordinates) of the person P acquired by the person position acquisition unit 212.

The prohibition area setting unit 214 (processor 21) determines the circular flight prohibition area E within a predetermined range centered on the position of the person P on the in-store flight map 241 acquired by the map position acquisition unit 213. Specifically, the prohibition area setting unit 214 sets the flight prohibition area E within the predetermined range centered on a position on the in-store flight map 241 at which the person P is located.

The prohibition area setting unit 214 may predict the position of the person P after a predetermined period of time in consideration of the movement of the person P based on the position of the person P on the in-store flight map 241 acquired by the map position acquisition unit 213, and set the flight prohibition area E of the predetermined range centered on the predicted position. In this case, the images captured by the fixed-point camera 30 are continuously acquired at regular intervals, the prohibition area setting unit 214 determines a moving speed and a moving direction of the person P from the acquired continuous images, predicts a moving distance and a moving direction of the person P by the time the flight object 40 reaches a position of the moving person P, and sets the flight prohibition area E centered on the predicted position of the person P.

The path review unit 215 (processor 21) reviews the flight path from the current position of the flight object 40 to the destination based on the set flight prohibition area E. Specifically, the path review unit 215 resets the flight path of the flight object 40 so as to avoid the flight prohibition area E set on the in-store flight map 241. The path review unit 215 (processor 21) does not reset (does not review) the flight path when the currently set flight path does not pass through the set flight prohibition area E.

The instruction information change unit 216 (processor 21) changes the currently set instruction information to instruction information related to a reviewed flight path of the flight object 40. Specifically, the instruction information change unit 216 changes the instruction information such that a direction in which the flight object 40 is currently flying is changed to the direction of the flight object 40 based on the changed flight path. When the path review unit 215 does not reset the flight path, the instruction information change unit 216 does not change the instruction information in the direction of the flight object 40 based on the changed flight path.

The instruction information transmission unit 217 (processor 21) transmits the information on the changed flight path to the flight object 40 via the NIC 25.

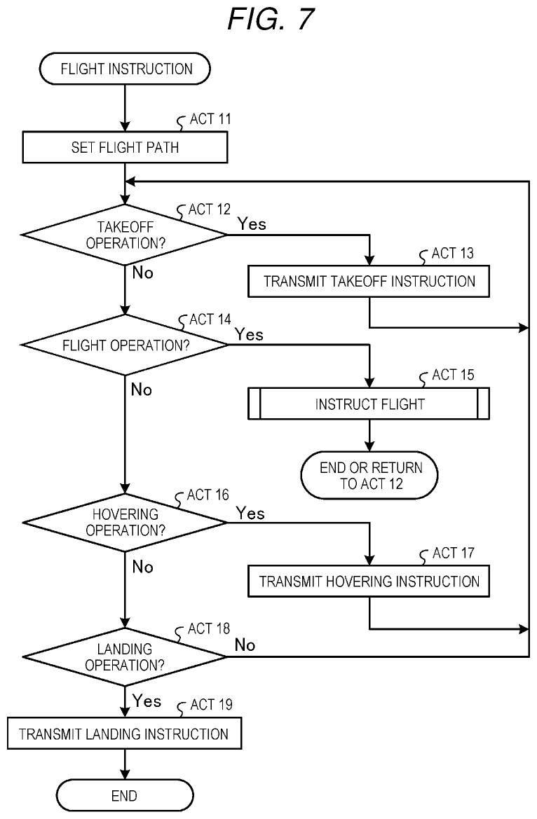

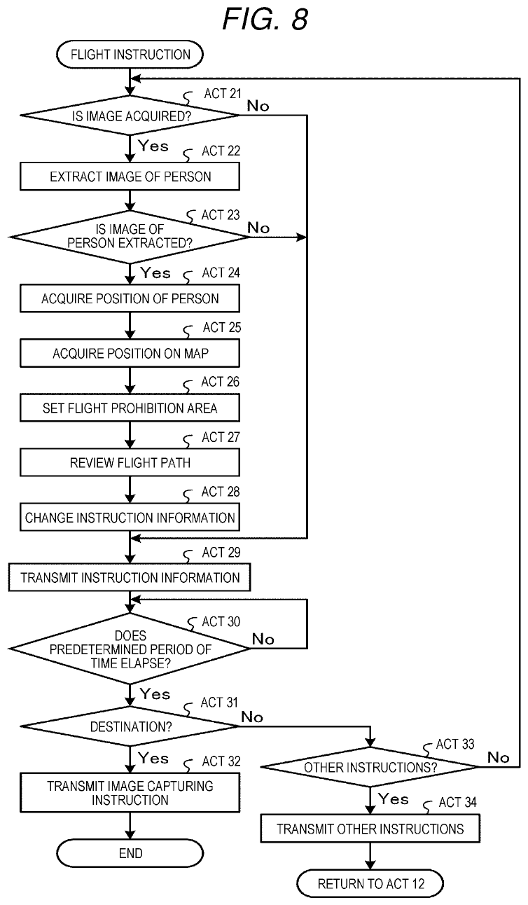

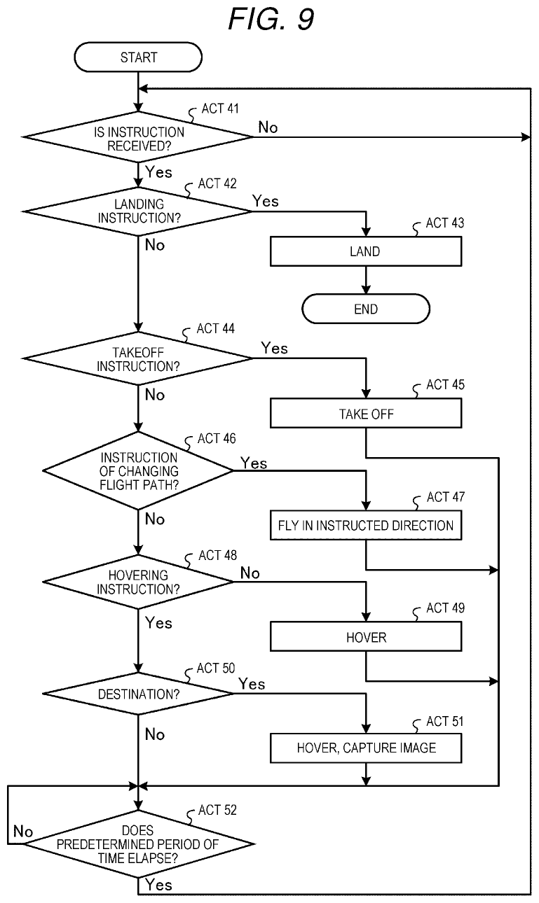

Hereinafter, control of the flight instruction device 20 will be described. FIG. 7 is a flowchart illustrating an example of a flow of control of the flight instruction device 20. FIG. 8 is a flowchart illustrating an example of a flow of control related to resetting a movement path of the flight instruction device 20. As illustrated in FIG. 7, the processor 21 initializes the flight path of the flight object 40 on the in-store flight map 241 based on the current position and the destination of the flight object 40 (Act 11). Specifically, when the destination is selected from the destination list 242, the processor 21 sets a flight path connecting the current position of the flight object 40 and the selected destination (Act 11).

Next, the processor 21 determines whether the takeoff operation of the flight object 40 is performed in the flight instruction device 20 (Act 12). When determining that the takeoff operation is performed (Yes in Act 12), the processor 21 transmits information indicating the takeoff instruction to the flight object 40 (Act 13). The processor 21 returns to Act 12.

When determining that the takeoff operation is not performed (No in Act 12), the processor 21 determines whether a flight operation of the flight object 40 is performed in the flight instruction device 20 (Act 14). When determining that the flight operation is performed (Yes in Act 14), the processor 21 instructs the flight of the flight object 40 (Act 15). The processor 21 returns to Act 12.

Hereafter, the flight instruction in Act 15 will be described. As illustrated in FIG. 8, the processor 21 determines whether a captured image is acquired from the fixed-point camera 30 (Act 21). For example, captured images are continuously acquired at predetermined time intervals from the fixed-point camera 30. When the processor 21 determines that the captured image is acquired from the fixed-point camera 30 (Yes in Act 21), the person extraction unit 211 attempts to extract the image of the person P from the acquired image (Act 22). The processor 21 determines whether the image of the person P is extracted from the acquired image (Act 23).

When the processor 21 determines that the image of the person P is extracted from the acquired image (Yes in Act 23), the person position acquisition unit 212 acquires the position (coordinates) of the captured person P based on the image of the person P extracted by the person extraction unit 211 (Act 24). Next, the map position acquisition unit 213 acquires the position (coordinates) of the person P on the in-store flight map 241 based on the position of the person P acquired by the person position acquisition unit 212 (Act 25). The prohibition area setting unit 214 sets the flight prohibition area E on the in-store flight map 241 centered on the acquired position of the person P on the in-store flight map 241 (or by predicting the position of the person P after the predetermined period of time) (Act 26).

Next, the path review unit 215 reviews the flight path of the flight object 40 such that the flight path set in Act 11 avoids the flight prohibition area E set on the in-store flight map 241 (Act 27). That is, the processor 21 resets, on the in-store flight map 241, the flight path that avoids the flight prohibition area E. The instruction information change unit 216 changes the instruction information related to the flight path of the flight object 40 based on the reset flight path (Act 28). The instruction information transmission unit 217 transmits the changed instruction information to the flight object 40 (Act 29).

When the processor 21 determines in Act 21 that the captured image is not acquired from the fixed-point camera 30 (No in Act 21), and when the image of the person P was not extracted in Act 23 (No in Act 21), the processor 21 executes the processing in Act 29. In this case, the instruction information is information indicating that the flight path is not changed.

Next, the processor 21 determines whether a predetermined period of time elapses in the timer 23 after the image is acquired in Act 21 (whether the timer 23 counts the predetermined time) (Act 30). The processor 21 is on standby until the predetermined time elapses (No in Act 30). When determining that the predetermined time elapses, the processor 21 determines whether the flight object 40 reaches the destination (Act 31). The flight instruction device 20 constantly receives information (coordinates) on a current flight position of the flight object 40 from the flight object 40, and determines whether the flight object 40 reaches the destination based on whether the information on the flight position coincides with the information on the position of the destination. When determining that the flight object 40 reaches the destination (Yes in Act 31), the processor 21 transmits an image capturing instruction to the flight object 40 (Act 32). The processor 21 ends the processing.

When determining that the flight object 40 does not reach the destination (No in Act 31), the processor 21 determines whether other instructions (hovering operation or landing operation) are operated (Act 33). When other instructions are performed (Yes in Act 33), the instructed instruction information is transmitted to the flight object 40 (Act 34). The processor 21 returns to Act 12. When determining that no other instruction is performed (No in Act 33), the processor 21 returns to Act 21.

Return to FIG. 7. When determining in Act 14 that the flight operation is not performed (No in Act 14), the processor 21 determines whether the hovering operation is performed (Act 16). When determining that the hovering operation is performed (Yes in Act 16), the processor 21 transmits hovering instruction information to the flight object 40 (Act 17). The processor 21 returns to Act 12.

When determining that the hovering operation is not performed (No in Act 16), the processor 21 determines whether the landing operation is performed (Act 18). When determining that the landing operation is performed (Yes in Act 18), the processor 21 transmits instruction information for instructing the landing to the flight object 40 (Act 19). The processor 21 ends the processing. When determining that the landing operation is not performed (No in Act 18), the processor 21 returns to Act 12.

Hereinafter, control of the flight object 40 will be described. The processor 41 of the flight object 40 determines whether the instruction information is received from the flight instruction device 20 (Act 41). The processor 41 is on standby until the instruction information is received (No in Act 41). When determining that the instruction information is received (Yes in Act 41), the processor 41 determines whether instruction information for instructing the landing is received (Act 42). When the instruction information for instructing the landing is received (Yes in Act 42), the processor 41 controls the rotation of the motors 46 to 49 to land the flight object 40 (Act 43). The processor 41 ends the processing.

When determining that the instruction information for instructing the landing is not received (No in Act 42), the processor 41 determines whether instruction information for instructing the takeoff is received (Act 44). When the instruction information for instructing the takeoff is received (Yes in Act 44), the processor 41 controls the rotation of the motors 46 to 49 to take off the flight object 40 (Act 45). The processor 41 ends the processing.

When determining that the instruction information for instructing the takeoff is not received (No in Act 44), the processor 41 determines whether instruction information for instructing a change in the flight path is received (Act 46). When the instruction information for instructing the change in the flight path is received (Yes in Act 46), the processor 41 controls the rotation of the motors 46 to 49 to change the flight path of the flight object 40 (Act 47). The processor 41 ends the processing.

When determining that the instruction information for instructing the change in the flight path is not received (No in Act 46), the processor 41 determines whether instruction information for instructing the hovering is received (Act 48). When the instruction information for instructing the hovering is received (Yes in Act 48), the processor 41 controls the rotation of the motors 46 to 49 to control the hovering that the flight object 40 is stopped moving and stays in a current place (in the air) (Act 49). The processor 41 ends the processing.

When determining that the instruction information for instructing the hovering is not received (No in Act 48), the processor 41 determines whether the flight object 40 reaches the destination (Act 50). When determining that the flight object 40 reaches the destination (Yes in Act 50), the processor 41 controls the rotation of the motors 46 to 49 to control the hovering of the flight object 40 (Act 51). The processor 41 drives the camera 55 mounted on the flight object 40 to capture an image of a product displayed on the shelf T at the destination (Act 51). The image of the product in Act 51 may be captured upon receiving image capturing instruction information from the flight instruction device 20. The processor 41 ends the processing.

When determining that the flight object 40 does not reach the destination (No in Act 50), the processor 41 determines whether a predetermined period of time elapses in the timer 43 after the processing of Act 41 (whether the timer 43 counts the predetermined period of time) (Act 52). The processor 41 is on standby until the predetermined time elapses (No in Act 52). When the processor 41 determines that the predetermined period of time elapses (Yes in Act 52), the processor 41 returns to Act 41.

According to the first embodiment, the flight instruction device 20 includes: the storage device 24 that stores the in-store flight map 241 for determining the movement path to the destination of the flight object 40 in the store N; and the processor 21 that sets the flight prohibition area E of the flight object 40 on the in-store flight map 241 based on the image of person P acquired from the fixed-point camera 30, reviews the flight path of the flight object 40 based on the current position, the destination, and the set flight prohibition area E of the flight object 40, and instructs the flight object 40 with the reset flight path information.

The flight instruction device 20 sets the flight prohibition area E based on the image of the person P captured by the fixed-point camera 30 attached to other than the flight object 40, and reviews the flight path that avoids the flight prohibition area E. Therefore, a risk when the flight object 40 flies can be avoided.

In the first embodiment, the flight instruction device 20 acquires the position of the person P on the in-store flight map 241, sets the flight prohibition area E, resets the flight path, and transmits the instruction to the flight object 40. However, the embodiment is not limited thereto, and for example, the flight instruction device 20 may acquire the position of the person P on the in-store flight map 241, and review the flight prohibition area E on the in-store flight map 241 based on the position acquired by the flight object 40. In this case, the in-store flight map 241 is stored by the flight object 40, and the flight object 40 instructs itself in the flight path based on the reset flight path. In this case, the flight management device 10 is an example of the movement instruction device.

The flight instruction device 20 may transmit the image captured by the fixed-point camera 30 to the flight object 40, so that the flight object 40 may acquire the position of the person P on the in-store flight map 241, set the flight prohibition area E, and review the flight path. In this case as well, the in-store flight map 241 is stored by the flight object 40, and the flight object 40 instructs itself in the flight path based on the reset flight path. In this case, the flight management device 10 is an example of the movement instruction device.

In the first embodiment, an obstacle may be an object other than the person P. For example, another flight object 40 may be the obstacle.

### Second Embodiment

Hereinafter, a second embodiment will be described. In the second embodiment, a self-propelled robot that travels in the passage F will be described as an example of the movable object. A travel management device 60 will be described as an example of the movement instruction device. The person P and an object temporarily placed in the passage F will be described as an example of the obstacle. In the second embodiment, the same components as those in the first embodiment are denoted by the same reference numerals, and the description thereof will be simplified or omitted.

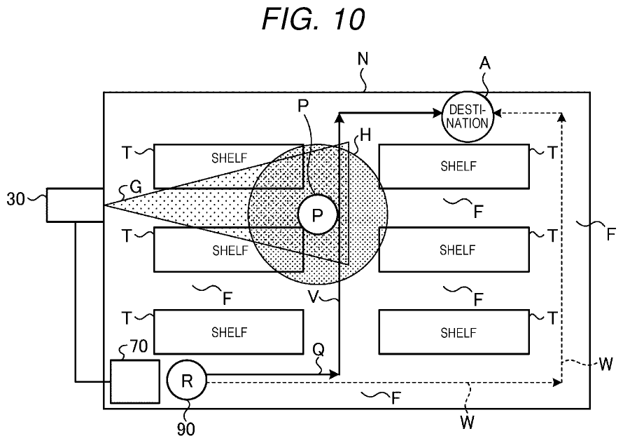

FIG. 10 is a diagram illustrating a review of a travel path (movement path) of a self-propelled robot 90 (see FIG. 13) according to the second embodiment. As illustrated in FIG. 10, for example, six shelves T are arranged in the store N. The passages F are provided between the shelves T. The person P such as a customer shopping in the store N or an employee passes through the passage F. The self-propelled robot 90 also travels in the passage F.

The fixed-point camera 30 that captures an image at a fixed point in the store is attached to the store N. The fixed-point camera 30 captures, in the imaging range G, an image of the person P who passes through the passage F. The attaching position and the number of the fixed-point camera 30 are the same as those in the first embodiment.

A prohibition area information generator 70, which constitutes a part of the movement instruction device, is installed in the store N. The prohibition area information generator 70 transmits information indicating a travel prohibition area H to the self-propelled robot 90.

The self-propelled robot 90 creates a travel path along which the self-propelled robot 90 travels to the destination. As illustrated in FIG. 10, the self-propelled robot 90 creates a travel path V along which the self-propelled robot 90 travels to the destination A, and the self-propelled robot 90 stores the created travel path V and travels along the travel path V. However, when the person P is located in the travel path V based on the image captured by the fixed-point camera 30, the prohibition area information generator 70 generates information indicating the travel prohibition area H based on the position of the person P (or the position to which the person is predicted to move). The self-propelled robot 90 reflects the information indicating the travel prohibition area H on an in-store travel map 941 (see FIG. 13) to review the travel path of the self-propelled robot 90. That is, the self-propelled robot 90 creates and resets a bypass travel path W such that the self-propelled robot 90 does not travel in the travel prohibition area H. The self-propelled robot 90 issues a travel instruction so that the self-propelled robot 90 itself travels based on the reset travel path W. Here, the travel instruction is an instruction related to a moving direction or a speed in the forward direction, the rearward direction, the leftward direction, or the rightward direction according to the location.

In the second embodiment, when the travel prohibition area H is present, the travel path to the destination A is reset. To be exact, the self-propelled robot 90 repeats an operation of setting a travel path to a target location close to the destination A each time on the way to the destination A, setting a travel path to the next destination when the destination is reached and travelling to the destination, and finally reaches the destination A.

A self-propelled robot in the related art can confirm the presence of the person P only after traveling to a point Q in FIG. 10 or after changing a direction thereof at the point Q. However, according to the second embodiment, by reviewing the travel path of the self-propelled robot 90 before the self-propelled robot 90 reaches the point Q, it is possible to prevent a time loss in which the self-propelled robot 90 temporarily stops at the point Q or detects the person P by changing a direction of the self-propelled robot 90.

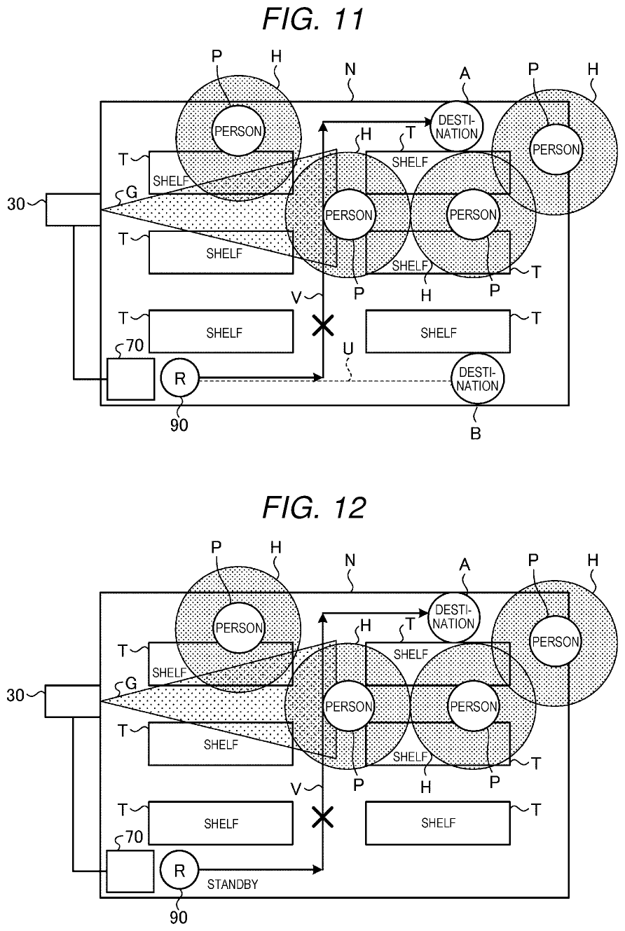

FIG. 11 is a diagram illustrating changes in the destination of the self-propelled robot 90. In FIG. 11, there are four persons P in the store N. The self-propelled robot 90 sets the travel prohibition areas H based on the positions of the respective persons P. In FIG. 11, as a result of reviewing the travel path based on the set travel prohibition areas, the self-propelled robot 90 determines that the travel path in which the self-propelled robot 90 travels along the passage F to the destination A cannot be reset, and for example, the travel path is changed to the destination B that is the destination to travel after reaching the destination A. The changed travel path is a travel path U. The self-propelled robot 90 controls the self-propelled robot 90 to travel along the travel path U.

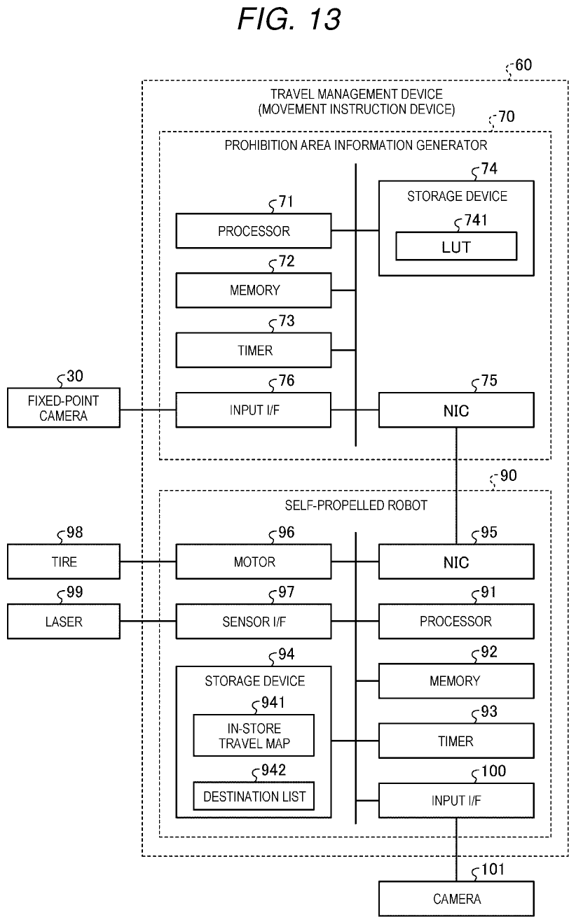

FIG. 12 is a diagram illustrating the self-propelled robot 90 on standby. In FIG. 12, there are four persons P in the store N. The self-propelled robot 90 sets the travel prohibition areas H based on the positions of the respective persons P. In FIG. 12, as a result of reviewing the travel path based on the set travel prohibition areas H, the self-propelled robot 90 determines that the travel path along which the self-propelled robot 90 travels to the destination A cannot be reset. For example, when no destination other than the destination A is set, the self-propelled robot 90 controls the self-propelled robot 90 to standby without traveling from a current position thereof.

Next, hardware configurations of the prohibition area information generator 70 and the self-propelled robot 90 will be described. The prohibition area information generator 70 and the self-propelled robot 90 constitute the travel management device 60 (that is, movement instruction device). FIG. 13 is a block diagram illustrating examples of the hardware configurations of the prohibition area information generator 70 and the self-propelled robot 90. The prohibition area information generator 70 includes, a processor 71 including a CPU and the like, a memory 72 including a ROM, a RAM, or the like, a timer 73, a storage device 74, a NIC 75, and an input I/F 76. The processor 71, the memory 72, the timer 73, and the storage device 74 correspond to the processor 21, the memory 22, the timer 33, and the storage device 24 according to the first embodiment. The processor 71 operates in accordance with a control program stored in the memory 72 to execute control processing of the prohibition area information generator 70 to be described later. The NIC 75 is a card-type expansion device for connecting to a communication network.

The storage device 74 stores a control program that controls the prohibition area information generator 70. The storage device 74 stores a LUT 741. The LUT 741 corresponds to the LUT 243 according to the first embodiment.

The self-propelled robot 90 includes, a processor 91 including a CPU and the like, a memory 92 including a ROM, a RAM, or the like, a timer 93, a storage device 94, a NIC 95, a motor 96, a sensor I/F 97, and an input I/F 100. The processor 91, the memory 92, the timer 93, the storage device 94, and the NIC 95 correspond to the processor 41, the memory 42, the timer 43, the storage device 44, and the NIC 45 according to the first embodiment. The processor 91 operates in accordance with a control program stored in the memory 92 to execute control processing of the self-propelled robot 90 to be described later.

The storage device 94 includes the in-store travel map 941 and a destination list 942. The in-store travel map 941 and the destination list 942 correspond to the in-store flight map 241 and the destination list 242 of the first embodiment. The input I/F 100 is connected to a camera 101 mounted on the self-propelled robot 90 to receive an image captured by the camera 101.

The motor 96 rotates a tire 98 for controlling the self-propelled robot 90 to travel. A rotation speed of the tire 98 changes according to a rotation speed of the motor 96. When the processor 41 rotates the tire 98, the self-propelled robot 90 travels, changes directions, and stops operations.

The sensor I/F 97 is connected to a laser 99. The laser 99 is mounted on the self-propelled robot 90. The laser 99 emits laser beam around (mainly toward the front of) the self-propelled robot 90, and the shelf T or an article placed in the passage F is detected using reflected light, whereby collision of the self-propelled robot 90 is prevented. The NIC 95 and the NIC 75 are connected to a communication line such as a wireless LAN, and transmit and receive information between the prohibition area information generator 70 and the self-propelled robot 90.

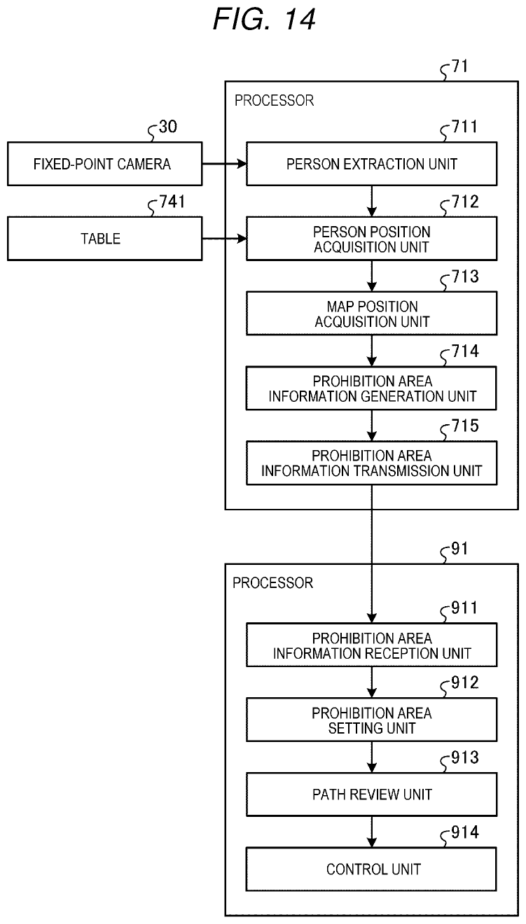

Hereinafter, functional configurations of the prohibition area information generator 70 and the self-propelled robot 90 will be described. FIG. 14 is a functional block diagram illustrating examples of the functional configurations of the prohibition area information generator 70 and the self-propelled robot 90. As illustrated in FIG. 14, the processor 71 of the prohibition area information generator 70 functions as a person extraction unit 711, a person position acquisition unit 712, a map position acquisition unit 713, a prohibition area information generation unit 714, and a prohibition area information transmission unit 715 in accordance with the control program stored in the memory 72.

The person extraction unit 711 (processor 71), the person position acquisition unit 712 (processor 71), and the map position acquisition unit 713 (processor 71) correspond to the person extraction unit 211, the person position acquisition unit 212, and the map position acquisition unit 213 according to the first embodiment.

The prohibition area information generation unit 714 (processor 71) generates travel prohibition area information in which the travel prohibition area H is within a circle of a predetermined distance centered on the position of the person P on the map acquired by the map position acquisition unit 213.

The prohibition area information transmission unit 715 (processor 71) transmits the travel prohibition area information generated by the prohibition area information generation unit 714 to the self-propelled robot 90.

The processor 91 of the self-propelled robot 90 functions as a prohibition area information reception unit 911, a prohibition area setting unit 912, a path review unit 913, and a control unit 914 in accordance with the control program stored in the memory 92.

The prohibition area information reception unit 911 (processor 91) receives the travel prohibition area information transmitted by the prohibition area information transmission unit 715.

The prohibition area setting unit 912 (processor 91) and the path review unit 913 (processor 91) correspond to the prohibition area setting unit 214 and the path review unit 215 according to the first embodiment. The prohibition area setting unit 912 sets the travel prohibition area H of the self-propelled robot 90. The path review unit 913 reviews the travel path on the passage F along which the self-propelled robot 90 travels. Specifically, the path review unit 913 resets the travel path of the self-propelled robot 90 so as to avoid the travel prohibition area H set on the in-store travel map 941.

The control unit 914 (processor 91) instructs the self-propelled robot 90 to travel along the travel path reset by the path review unit 913. The control unit 914 controls the self-propelled robot 90 to travel to the destination based on the instructed travel path.

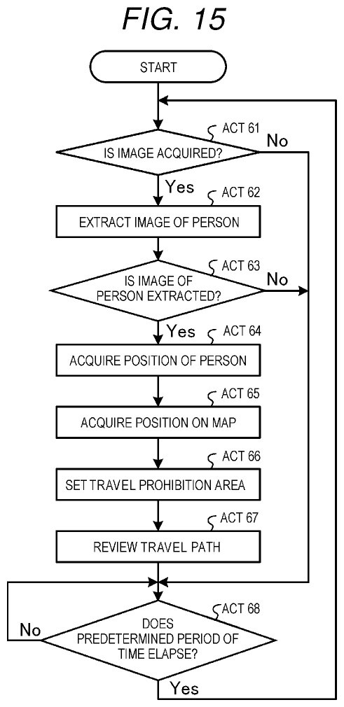

Hereinafter, control of the prohibition area information generator 70 will be described. FIG. 15 is a flowchart illustrating a flow of control of the prohibition area information generator 70. As illustrated in FIG. 15, the processor 71 of the prohibition area information generator 70 determines whether the image captured by the fixed-point camera 30 is acquired from the fixed-point camera 30 (Act 61). When the processor 71 determines that the captured image is acquired from the fixed-point camera 30 (Yes in Act 61), the person extraction unit 711 attempts to extract the image of the person P from the acquired image (Act 62).

Next, the processor 71 determines whether the person extraction unit 711 extracts the image of the person P (Act 63). When the processor 71 determines that the image of the person P is extracted (Yes in Act 63), the person position acquisition unit 712 acquires the position (coordinates) of the captured person P based on the image of the person P extracted by the person extraction unit 711 (Act 64). Next, the map position acquisition unit 713 acquires the position (coordinates) of the person P on the in-store travel map 941 based on the position of the person P acquired by the person position acquisition unit 712 (Act 65). Next, the prohibition area information generation unit 714 generates the travel prohibition area information in which the travel prohibition area H is within a circumference centered on the acquired position of the person P (Act 66). The prohibition area information transmission unit 715 transmits the travel prohibition area information generated by the prohibition area information generation unit 714 to the self-propelled robot 90 (Act 67).

Next, the processor 71 determines whether a predetermined period of time elapses after the image is acquired in Act 61 (whether the timer 73 counts the predetermined period of time) (Act 68). The processor 71 is on standby until the predetermined period of time elapses (No in Act 68). When the processor 71 determines that the predetermined period of time elapses (Yes in Act 68), the processor 71 returns to Act 61. When the processor 71 determines in Act 61 that the image is not acquired (No in Act 61), or when the person extraction unit 711 cannot extract the image of the person P in Act 63 (No in Act 63), the processor 71 executes the processing in Act 68.

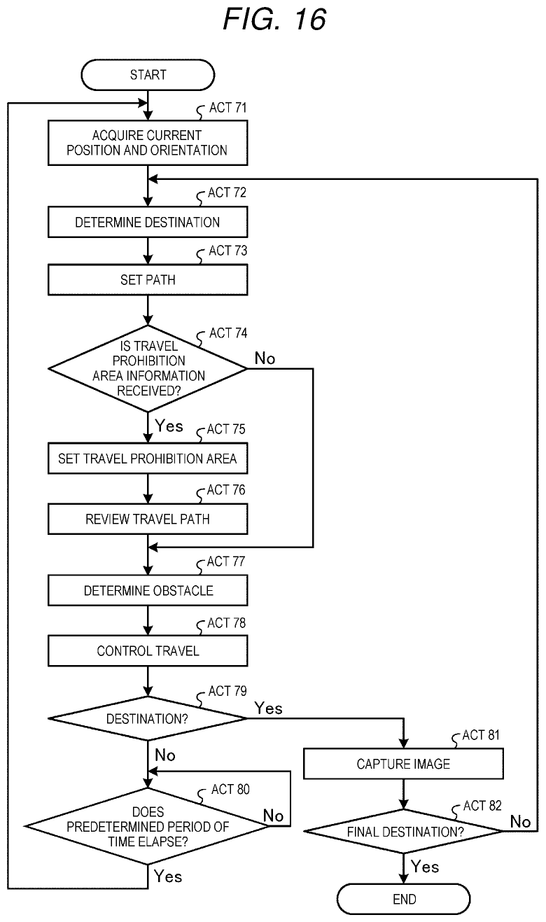

Hereinafter, control of the self-propelled robot 90 will be described. FIG. 16 is a flowchart illustrating a flow of control of the self-propelled robot 90. As illustrated in FIG. 16, the processor 91 acquires information on a current position and an orientation of the self-propelled robot 90 (Act 71). Next, the processor 91 determines a desired destination from the destination list 942 (Act 72). Next, the processor 91 determines a travel path along which the self-propelled robot 90 travels based on the current position, the orientation, and the determined destination, and sets the travel path on the in-store travel map 941 (Act 73).

Next, the processor 91 determines whether the prohibition area information reception unit 911 receives the travel prohibition area information from the prohibition area information generator 70 (Act 74). When the processor 91 determines that the prohibition area information reception unit 911 receives the travel prohibition area information (Yes in Act 74), the prohibition area setting unit 912 sets the travel prohibition area H on the in-store travel map 941 based on the received travel prohibition area information (Act 75).

Next, the path review unit 913 reviews the travel path of the self-propelled robot 90 such that the travel path set in Act 73 avoids the travel prohibition area H set on the in-store travel map 941 (Act 76). That is, the path review unit 913 resets another travel path that avoids the travel prohibition area H on the in-store travel map 941. Next, the processor 91 determines whether there is an obstacle (for example, an article temporarily placed in the path) in the vicinity of a position where the self-propelled robot 90 is currently located using the laser 99 (Act 77).

Next, the control unit 914 instructs the self-propelled robot 90 to travel along the travel path reviewed by the path review unit 913 (Act 78). The control unit 914 issues a travel instruction so that the self-propelled robot 90 travels to the destination based on the instructed travel path (Act 78). The processor 91 determines whether the self-propelled robot 90 reaches the destination (Act 79). When coordinates of the destination and coordinates where the self-propelled robot is currently located match or almost match, the processor 91 determines that the destination is reached. When determining that the destination is not reached (No in Act 79), the processor 91 determines whether a predetermined period of time elapses after receiving the travel prohibition area information (whether the timer 93 counts the predetermined period of time) (Act 80). The processor 91 is on standby until the predetermined time elapses (No in Act 80). When determining that the predetermined period of time elapses (Yes in Act 80), the processor 91 returns to Act 71.

When determining that the destination is reached (Yes in Act 79), the processor 91 uses the camera 101 to capture an image of a product displayed on the shelf T at the reached position (Act 81). Next, the processor 91 determines whether the destination is the final destination (Act 82). The processor 91 determines whether the destination is the final destination based on whether the current position of the self-propelled robot 90 matches an initial destination set in Act 72. When determining that the destination is not the final destination (No in Act 82), the processor 91 returns to Act 72. When determining that the destination is the final destination (Yes in Act 82), the processor 91 stops the traveling of the self-propelled robot 90 at the position and ends the processing.

When determining in Act 74 that the prohibition area information reception unit 911 does not receive the travel prohibition area information (No in Act 74), the processor 91 executes the processing of Act 77.

According to the second embodiment, the prohibition area information generator 70, which is a part of the travel management device 60, generates prohibition area information based on the information on the person P obtained from the fixed-point camera 30. The self-propelled robot 90, which is a part of the travel management device 60, includes the storage device 94 that stores the in-store travel map 941 for determining the travel path to the destination of the self-propelled robot 90 in the store N, sets the travel prohibition area H of the self-propelled robot 90 on the in-store travel map 941 based on the prohibition area information generated by the prohibition area information generator 70, and reviews the travel path of the self-propelled robot 90 based on the current position, the destination, and the set travel prohibition area H of the self-propelled robot 90.

The travel management device 60 sets the travel prohibition area H centered on the person P based on the image of the person P captured by the fixed-point camera 30 attached to other than the self-propelled robot 90, and reviews the travel path that avoids the travel prohibition area H. Therefore, a risk when the self-propelled robot 90 travels can be avoided.

In the second embodiment, the prohibition area information generator 70 of the travel management device 60 generates the prohibition area information based on the information on the person P obtained from the fixed-point camera 30, so that the self-propelled robot 90 sets the travel prohibition area H, reviews the travel path, and instructs the self-propelled robot 90 to travel along the reviewed travel path. However, the embodiment is not limited thereto, and for example, the prohibition area information generator 70 may be a LUT that generates the prohibition area information, so that the self-propelled robot 90 may generate the prohibition area information, set the travel prohibition area H, and review the travel path.

The prohibition area information generator 70 may generate the prohibition area information based on the information on the person P obtained from the fixed-point camera 30, set the travel prohibition area H, and review the travel path. In this case, the prohibition area information generator 70 is a movement instruction device. In this case, similarly to the flight object 40 according to the first embodiment, the self-propelled robot 90 travels along the travel path instructed by the prohibition area information generator 70.

While the embodiments described herein have been explained above, these embodiments have been presented by way of example only, and are not intended to limit the scope of the disclosure. These novel embodiments can be implemented in various other forms, and various omissions, substitutions, and modifications may be made without departing from the spirit of the disclosure. The embodiments and the modification thereof are included in the scope and gist of the disclosure, and are included in the scope of the claims and equivalents thereof.

For example, in the first embodiment and the second embodiment, the image captured by the fixed-point camera 30 is used as the “information on an obstacle obtained from the outside”. However, the embodiments are not limited thereto, and the “information on an obstacle obtained from the outside” may be, for example, information on a fixed beacon that detects the position of the person P. When the person P carries a global positioning system (GPS) terminal, the information may be position information on the GPS terminal obtained from the GPS.

In the first embodiment and the second embodiment, the movable object is described as moving in the store N. However, the embodiments are not limited thereto, and for example, the movable object may move indoors such as in a warehouse.

A program executed by the movement instruction device according to the first embodiment and the second embodiment is provided by being recorded, as a file in an installable or executable format, on a computer-readable recording medium such as a CD-ROM, a flexible disk (FD), a CD-R, and a digital versatile disk (DVD).

The program executed by the movement instruction device according to the first embodiment and the second embodiment may be stored on a computer connected to a network such as the Internet and provided by being downloaded via the network. The program executed by the movement instruction device according to the first embodiment and the second embodiment may be provided or distributed via the network such as the Internet.

The program executed by the movement instruction device according to the first embodiment and the second embodiment may be provided by being incorporated in a ROM or the like in advance.

What is claimed is:

1. A movement instruction device, comprising:
a storage device that stores map information for determining a movement path of an indoor movable object to a destination; and
a processor that sets a movement prohibition area of the indoor movable object in the map information based on information on an obstacle obtained from outside, and reviews the movement path of the indoor movable object based on a current position, the destination, and the set movement prohibition area of the indoor movable object.

2. The movement instruction device according to claim 1, wherein
the processor receives an image of the obstacle captured by a fixed-point camera attached indoors as the information on the obstacle obtained from the outside.

3. The movement instruction device according to claim 2, wherein
the processor predicts and reviews an area where the obstacle may move in a certain period of time based on the image received from the fixed-point camera.

4. The movement instruction device according to claim 1, wherein
the indoor movable object is a flight object configured to fly indoors, and
the processor sets a flight prohibition area of the flight object as the movement prohibition area, and reviews a flight path of the flight object as the movement path.

5. The movement instruction device according to claim 1, further comprising:
a prohibition area information generator; and
a self-propelled robot, wherein
the prohibition area information generator comprises a processor that generates movement prohibition area information on the indoor movable object based on the information on the obstacle obtained from the outside and transmits the movement prohibition area information to the self-propelled robot,
the self-propelled robot comprises a processor that sets a movement prohibition area of the movable object in the map information based on the received movement prohibition area information, and reviews the movement path of the indoor movable object based on the current position, the destination, and the set movement prohibition area of the indoor movable object.

6. The movement instruction device according to claim 1, wherein
the indoor movable object is a multi-rotor aerial drone.

7. The movement instruction device according to claim 1, wherein
the indoor movable object comprises a camera.

8. A method implemented by a computer serving as a movement instruction device, the movement instruction device including a processor and a storage device that stores map information for determining a movement path of an indoor movable object to a destination, the method causing the processor to:
set a movement prohibition area of the indoor movable object in the map information based on information on an obstacle obtained from outside, and
review the movement path of the indoor movable object based on a current position, the destination, and the set movement prohibition area of the indoor movable object.

9. The method according to claim 8, wherein
the processor receives an image of the obstacle captured by a fixed-point camera attached indoors as the information on the obstacle obtained from the outside.

10. The method according to claim 9, wherein
the processor predicts and reviews an area where the obstacle may move in a certain period of time based on the image received from the fixed-point camera.

11. The method according to claim 8, wherein
the indoor movable object is a flight object configured to fly indoors, and
the processor sets a flight prohibition area of the flight object as the movement prohibition area, and reviews a flight path of the flight object as the movement path.

12. The method according to claim 8, further comprising:
a prohibition area information generator; and
a self-propelled robot, wherein
the prohibition area information generator comprises a processor that generates movement prohibition area information on the indoor movable object based on the information on the obstacle obtained from the outside and transmits the movement prohibition area information to the self-propelled robot,
the self-propelled robot comprises a processor that sets a movement prohibition area of the movable object in the map information based on the received movement prohibition area information, and reviews the movement path of the movable object based on the current position, the destination, and the set movement prohibition area of the indoor movable object.

13. A store management system, comprising:
a movement instruction device, comprising:
a storage device that stores map information for determining a movement path of an indoor movable object to a destination; and
a processor that sets a movement prohibition area of the indoor movable object in the map information based on information on an obstacle obtained from outside (insert of “?”), and reviews the movement path of the movable object based on a current position, the destination, and the set movement prohibition area of the indoor movable object;
the indoor movable object; and
a fixed-point camera attached indoors.

14. The store management system according to claim 13, wherein
the processor receives an image of the obstacle captured by the fixed-point camera attached indoors as the information on the obstacle obtained from the outside.

15. The store management system according to claim 2, wherein
the processor predicts and reviews an area where the obstacle may move in a certain period of time based on the image received from the fixed-point camera.

16. The store management system according to claim 13, wherein
the indoor movable object is a flight object configured to fly indoors, and
the processor sets a flight prohibition area of the flight object as the movement prohibition area, and reviews a flight path of the flight object as the movement path.

17. The store management system according to claim 13, further comprising:
a prohibition area information generator; and
a self-propelled robot, wherein
the prohibition area information generator comprises a processor that generates movement prohibition area information on the movable object based on the information on the obstacle obtained from the outside and transmits the movement prohibition area information to the self-propelled robot,
the self-propelled robot comprises a processor that sets a movement prohibition area of the indoor movable object in the map information based on the received movement prohibition area information, and reviews the movement path of the movable object based on the current position, the destination, and the set movement prohibition area of the indoor movable object.

18. The store management system according to claim 13, wherein
the indoor movable object is a multi-rotor aerial drone.

19. The store management system according to claim 13, wherein
the indoor movable object comprises a camera.

20. The store management system according to claim 13, wherein
the store management system is an inventory management system.
